(19) United States
(12) Patent Application Publication
(10) Pub. No.: US 2024/0339779 A1
(43) Pub. Date: Oct. 10, 2024

(54) PLUG-IN CONNECTOR HAVING A FRAME

(71) Applicant: Amphenol Tuchel Industrial GmbH, Heilbronn (DE)

(72) Inventor: Pascal WÖLFFLE, Nordheim (DE)

(21) Appl. No.: 18/576,071

(22) PCT Filed: Jun. 27, 2022
(86) PCT No.: PCT/EP2022/067567

§ 371 Date: Jan. 2, 2024

(30) Foreign Application Priority Data
Jul. 1, 2021 (DE) 10 2021 116 996.8

(51) Int. Cl. H01R 13/518; H01R 13/52; H01R 13/64

(52) U.S. Cl. CPC H01R 13/518; H01R 13/5202; H01R 13/5219; H01R 13/64

(57) ABSTRACT

The invention relates to a plug-in connector, a plug-in connection for the electrically conductive and releasable contacting of contact elements, comprising a plug-in connector element and a mating plug-in connector element each having, on their plugging side, a plugging contour for blind plugging, wherein the plug-in connector element and/or the mating plug-in connector element has a frame which, as an adapter, allows fastening to a housing with any geometry, the frame having, at the surface for contact with the housing, a scaling surface.

### CROSS REFERENCE TO RELATED APPLICATIONS

This application is a National Stage application of PCT/EP2022/067567, filed Jun. 27, 2022, which claims the benefit of German Application No. 10 2021 116 996.8, filed Jul. 1, 2021, both of which are incorporated by reference in their entirety herein.

The disclosure relates to a plug-in connector (also referred to as a plug-in connection) for electrically conductive and releasable contacting of contact elements, including a plug-in connector plug and a mating plug-in connector plug, each with a plugging contour formed on its plugging side for blind plugging.

Plug-in connectors in a wide variety of configurations and variants are used for contacting or producing releasable electrically conductive connections. Plug-in connection solutions are available in a multitude of different configurations, for example with regard to the number of poles, electrical power ratings and the conditioning of a wide range of external influences such as humidity, temperature, corrosive media or mechanical loads.

Depending on the ambient conditions and the resulting effects, it should be ensured that the contacting task is carried out permanently, reliably and faultlessly. In order to achieve this aim, types of protection have been defined, expressed as

IP codes (IP=International Protection) and having test procedures with different ambient conditions stored for them.

Plug-in connectors, in particular for achieving various types of protection or IP codes, of IP classes are in many cases enclosed, housed, partially or fully sealed or even shielded by housings. Other requirements, such as for example sealing of the contacting elements, strain relief of the attached electrically conductive cables and lines, a large number of contacts in confined spaces, etc., may result in further special requirements for plug-in connector housings.

Another practically always existing requirement for plug-in connectors and their plug-in connector housings, sleeve housings, is the easy, reliable, cost-effectively achievable mounting of the components.

In addition, there may be plugging-in and contacting tasks that include both blind mounting and hermetic sealing against media of various types. There may be blind mounting situations (i.e. blind plugging) if the installation situation of the plug-in connection prevents a clear view of the mating plug or the contact elements to be contacted. In this case, the user must try to connect the parts to be plugged together by trial and error. A classic example is to plug a rack into a cabinet or place a music console on a charging station. There is always the risk of damaging the contact elements or the solutions provided for sealing the plug-in connection.

EP 3 790 126 A1 shows a plug-in connector unit suitable for blind mounting, formed by a connector assembly, including a supporting plate with an opening and a connector, including a flange and a fastening element, the connector being adapted to be mounted on the support plate, the mounting element being inserted into the opening. The opening includes: an insertion portion, which allows reversible insertion of the fastening element by translation perpendicularly to the supporting plate, and a locking portion, which receives the mounting element and locks it relative to the plate. The assembly also has a locking device, which is elastically deformed under the effect of a movement of the fastening element from the insertion region in the direction of the locking portion.

WO 02/47212 A1 shows a proposal of a solution for the structural design of a sealed plug-in connection with a frame. The multi-pole plug-in connector presented is designed for receiving a mating plug with a housing in which an insulating body with a number of contact inserts corresponding to the number of lines led through, each with a socket or pin, is arranged and, while maintaining the miniaturized plug pattern, is to be developed such that water ingress is prevented and the plug-in connector can be attached to a connection plate or a mating plug or a cover cap in a watertight manner. The insulating body is arranged with the contact inserts in a frame, which surrounds it and has sealant and which can be attached to the connection plate or a mating plug or a cover cap in such a way that the seal is pressed against it in each case.

The disclosure further develops and improve plug-in connections for blind plugging, i.e. blind mounting, and a simultaneous sealing function against external media and to reduce at least partially the disadvantages occurring in the prior art.

The disclosure recognizes that plug-in connections with a sealing function against media that are to be blindly plugged can be further developed by at least one frame, which is preferably a plastic frame and which can receive standard modules and be provided with seals, which seal-tightness against a housing part (mating plug side).

The plastic frame is provided with a geometry such that standard modules, i.e. plug-in modules including contact elements, can be received. The plastic frame has at least one surface which can lie against a seal and thus, together with other attachment parts, can achieve a tight plug-in connection. For this, a second frame, a potting frame, is attached in the connection area and the wiring space, i.e. a subspace of the plug-in connector plug, is potted with a sealing potting compound. As an alternative to the potting compound, the wiring space may be sealed with a sleeve housing.

With a seal, for example a flat gasket, lying against the sealing surface of the frame, the plug-in connector can be sealed on the outside against the other part involved in the plug-in connection, the mating plug or a housing in the case of fixed mounting.

The frame is the element that can be mounted on virtually any housing of the mating plug or the area around the mating plug and acts as an adapter with a sealing surface, so that mounting with a mating plug of different embodiments does not require specially adapted housings, but can use this solution directly as a seal-tight solution.

Between the contact elements, for example of the pin side and the socket side, a further seal, for example a profile seal, is sealed. The pin side and the socket side can optionally be designed as a common part. The flanged socket allows both fixed and floating mounting, depending on the installation position. The socket geometry has the effect that, depending on the installation orientation, i.e. either 0 degrees or 180 degrees, fixed or floating mounting is achieved.

The disclosure will be explained in more detail below on the basis of exemplary embodiments in connection with the figures, in which:

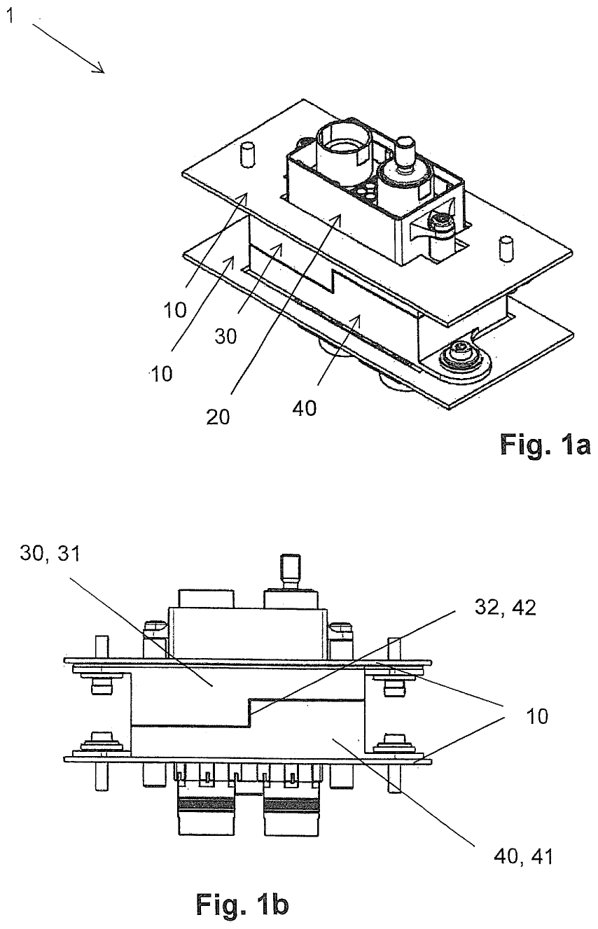

FIG. 1a shows the perspective view of a first exemplary embodiment of the plug-in connection with the frame and the potting frame;

FIG. 1b shows the front view of a first exemplary embodiment of the plug-in connection with the frame and the potting frame;

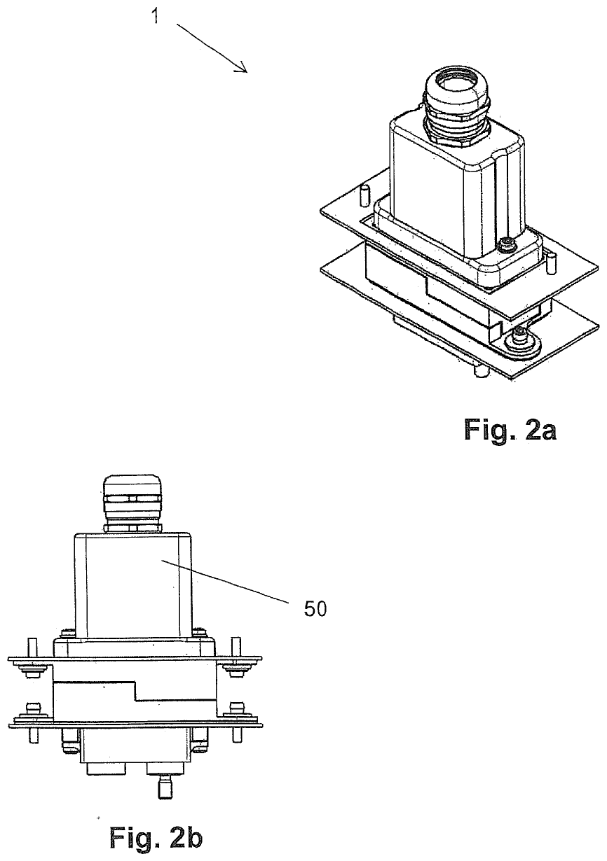

FIG. 2a shows the perspective view of a second exemplary embodiment of the plug-in connection with the frame and the sleeve housing;

FIG. 2b shows the front view of a second exemplary embodiment of the plug-in connection with the frame and the sleeve housing;

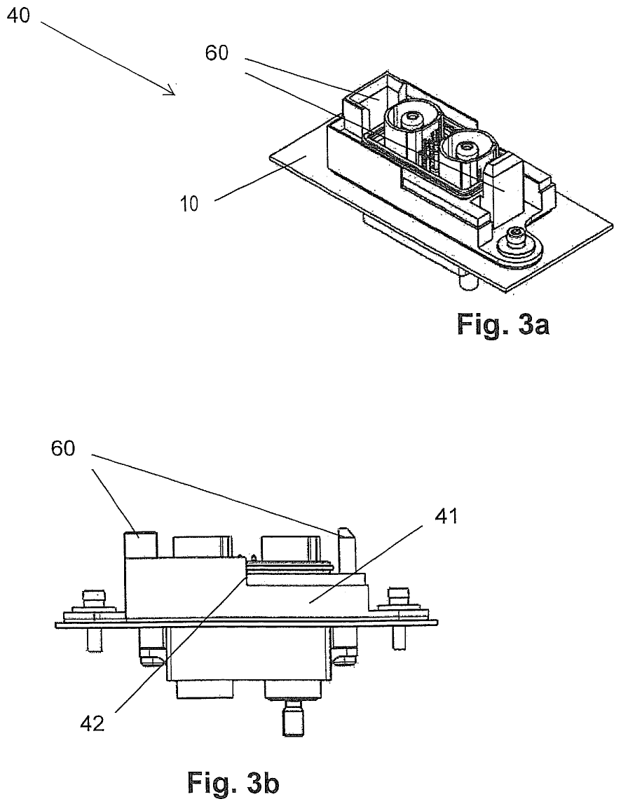

FIG. 3a shows the perspective view of the mating plug-in connector plug with the housing and the contacting elements;

FIG. 3b shows the front view of the mating plug-in connector plug.

FIG. 1a shows the perspective view of a first exemplary embodiment of the plug-in connection 1 (also called the plug-in connector) with the frame 10 and the potting frame 20. The plug-in connection 1 is formed by a plug-in connector plug 30 and a mating plug-in connector plug 40 as well as a frame 10 and a potting frame 20. The frame 10 is the element which is fixed at any mounting location, such as for example on a customer housing, and acts as an adapter with an optional seal (not shown), so that for different connector housings no specially adapted housings are required, but instead this solution can be used directly with the mounting-side housing as a seal-tight solution. The frame 10 has a sealing surface on its contact surface with respect to the housing.

The potting frame 20 may be formed as a separate element or integrative component of the plug-in connector plug housing 31 and frames the plug-in contact elements on the outside. Within the potting frame 20, potting compound 21 (not shown) is introduced, so that a media-tight seal is achieved.

The two plug-in connector plugs 30, 40 forming the plug-in connection 1 have formed on the respective plugging side a specific plugging contour 60, which is designed for “blind” plugging and the geometry of which is designed such that it is only possible for the plug-in contact elements of the plug-in connector plugs 30, 40 to be plugged together in the correct orientation.

The plugging contour 60 lies within the frames 10 and potting frame 20, so that a sealing function can be achieved on the plugging side with the plug-in connector housing 31, 41 enclosing the plugging contour 60. Optionally, a seal, for example a profile seal, may be provided on the circumferential contact face provided with a plug-in connector housing step 32, 42.

FIG. 1b includes the front view of a first exemplary embodiment of the plug-in connection 1 with the frame 10 and the potting frame 20. The plug-in connector plug 30 and the mating plug-in connector plug 40 have a plug-in connector plug housing 31 and mating plug-in connector plug housing 41, respectively, each with a plug-in connector housing step 32, 42.

FIG. 2a illustrates the perspective view and FIG. 2b shows the front view of a second exemplary embodiment of the plug-in connection 1 with the frame 10 and the sleeve housing 50. The sleeve housing 50 serves for sealing the outlet side of the plug-in connector plug 30 or the mating plug-in connector plug 40 (not shown) and replaces the potting compound 21.

FIG. 3a includes the perspective view and FIG. 3b the front view of the mating plug-in connector plug 40 with the frame 10 and the plugging contour 60. Both the plugging contour 60 and the plug-in connector housing step 42 are geometrically designed in such a way that the mounting is “blind” and the orientation of the plug-in contact elements of the plug-in connector plugs 30, 40 can allow correct plugging.

### LIST OF REFERENCE SIGNS

1 Plug-in connector, plug-in connection
10 Frame
20 Potting frame
21 Potting compound
30 Plug-in connector plug
31 Plug-in connector plug housing
32 Plug-in connector housing step
40 Mating plug-in connector plug
41 Mating plug-in connector plug housing
42 Plug-in connector housing step
50 Sleeve housing
60 Plugging contour

1. A plug-in connector for electrically conductive and releasable contacting of contact elements, comprising a plug-in connector plug and a mating plug-in connector plug, each with a plugging contour formed on its plugging side for blind plugging, wherein the plug-in connector plug and/or the mating plug-in connector plug has a frame which, as an adapter, allows fixing on a housing, preferably with any geometry, wherein the frame has a sealing surface at the contact surface with respect to the housing.

2. The plug-in connector as claimed in claim 1, wherein the plugging contour lies within the plug-in connector housing, so that a sealing function can be achieved by the plug-in connector housing.

3. The plug-in connector as claimed in claim 1, wherein the plug-in connector plug and/or the mating plug-in connector plug has a potting frame on its respective plug-in connector housing, wherein within the potting frame potting compound is introduced and thus a media-tight seal is achieved.

4. The plug-in connector as claimed in claim 1, wherein the plug-in connector plug and/or the mating plug-in connector plug has a sleeve housing on its respective plug-in connector housing, so that a media-tight seal is achieved.

5. The plug-in connector as claimed in claim 1, wherein the plugging contour has a geometry such that it is only possible for the plug-in contact elements of the plug-in connector plugs to be plugged together in the correct orientation.

6. The plug-in connector as claimed in claim 1, wherein the plug-in connector plug and the mating plug-in connector plug have a plug-in connector plug housing and a mating plug-in connector plug housing, respectively, each with a plug-in connector housing step.
